(19) United States
(12) Patent Application Publication
(10) Pub. No.: US 2023/0359159 A1
(43) Pub. Date: Nov. 9, 2023

(54) CONTROL SYSTEM AND METHOD FOR DISPLAYING DEDICATED CONTENT RELATED TO A BUILDING

(71) Applicant: AMIDO AB (PUBL), Göteborg (SE)

(72) Inventor: Peo EMGÅRD, Göteborg (SE)

(73) Assignee: AMIDO AB (PUBL), Göteborg (SE)

(21) Appl. No.: 18/021,673

(22) PCT Filed: Aug. 18, 2021
(86) PCT No.: PCT/SE2021/050811

§ 371 Date: Feb. 16, 2023

(30) Foreign Application Priority Data
Aug. 19, 2020 (SE) 2050963-4

(51) Int. Cl. G05B 19/042

(52) U.S. Cl. CPC G05B 19/042; G05B 2219/25011

(57) ABSTRACT

The present disclosure relates to a control system, for example adapted to selectively display dedicated content relating to guiding instructions or informative elements for a building. The present disclosure also relates to a corresponding method and a computer program product. The control system comprises a control unit arranged in communication with a display screen, an entry interface and a database holding building information relating to a plurality of building entities. The control unit is adapted to acquire, using the entry interface, a request from a user to interact with at least one building entity, the request comprising an identifier for the user. Based on the request, and from the database, building information related to the building entity is selected. A set of content is formed based on the user identifier and the selected building information. The set of content is displayed for the user.

### TECHNICAL FIELD

The present disclosure relates to a control system, for example adapted to selectively display dedicated content relating to guiding instructions or informative elements for a building. The present disclosure also relates to a corresponding method and a computer program product.

### BACKGROUND

Buildings shared by multiple occupants and possibly comprising a plurality of units often have directories arranged in the main entrance or main lobby that provide. Such directories are generally arranged to display information pertaining to the location of particular types of physical infrastructure, such as the location of specific units, restrooms, stairs, elevators, dining facilities, etc. A single unit within the building may for example be an apartment, an office, or any other piece of space requiring access control.

Generally, the mentioned directories are represented by printed signs, however such printed signs are often containing out-of-date information almost as soon as they are printed and hung. A modern approach to the printed sign is the use of an electronic display screen, allowing the information to be updated in an easier manner as well as allowing for the information to be presented in an interactive manner to the person requiring such information.

An example of such an interactive display screen is disclosed in US20100253643, suggesting the use of a large-screen electronic building directory system that also integrates advertising and non-commercial content and is positioned and deployed in various public spaces, such as commercial building lobbies, indoor shopping malls, airports or other commercial and transportation hubs. The system combines facility directory, facility services information, concessionaires and advertising sponsor information in a user interface suitable for use in the target environment.

The interactive presentation of information as is suggested by US20100253643 of course allows for a great improvement as compared to the printed signs. However, the scheme of presenting information may potentially make it hard for a person requiring specific information to easily get hold of that information, since useful information not necessary for the person is integrated with required useful information.

With this in mind, it would be desirable to present a new type of approach for selectively displaying relevant content relating to guiding instructions or informative elements for a building to the person requesting such information, specifically focusing on a reliable solution that may easily integrate with currently available hardware installed at the building.

### SUMMARY

According to an aspect of the present disclosure, the above is at least partly met by a control system installed at a building comprising a plurality of building entities, wherein the control system is adapted to display dedicated content, the system comprising a display screen, an entry interface for communicating with an entry system for the, a database holding building information relating to the building entities, the building entity being one of the plurality of units and the building, and a control unit arranged in communication with the display screen, the entry interface and the database, wherein the control unit is adapted to acquire, using the entry interface, a request from a user to interact with at least one building entity, the request comprising an identifier for the user, select, based on the request and from the database, building information relating to the building entity, form a set of content based on the user identifier and the selected building information, and display, using the display screen of the control system, the set of content for the user.

By means of the present disclosure, it will be possible to improve the selection of information that is presented to a user, by allowing the information to be “personalized” depending on a combination of an identity of the user and knowledge about what building entity the user wants to interact with. Accordingly, the same user interacting with two different building entities will not necessarily be presented with the same information, but rather information that is dependent of which building entity the user wants to interact with. Similarly, different users wanting to interact with the same building entity must not necessarily be presented with the same information.

In line with the present disclosure, an entry interface is used for allowing the user to interact with the control system. The entry interface may in line with the present disclosure be manifested using e.g. a “tag reader”, a touch screen or simply a keypad. Using any of these devices, the user may provide both his identifier and what building entity to interact with. In case the entry interface is a tag reader, the user may be provided with a readable tag provided as a separate physical entity (such as a key fob) or loaded with e.g. a mobile phone associated with the user. The tag may as such hold both the user identifier and information relating to the building entity of interest to the user. Such an implementation may for example be preferred in case the user is an occupant/tenant of the building.

In accordance with the present disclosure the display is arranged to visible to the person wanting to interact with the building entity at the same time as the entry interface is similarly accessible, even in case that person is located outside of an entry door of the building. An advantage following the present disclosure is thus also the ability to allow the person wanting to interact with the building entity is provided with specified information without the person having to resort to download a specific application to his mobile phone to be able to view the specified information. As indicated above, interaction may generally be performed using a key fob, key pad or similar. Thus, users not having regular interaction with the building will not even have to have a specifically configured mobile phone available, a simple key code may be sufficient to be provided with the specified information.

It should be noted that even though the present disclosure is here presented in relation to an example of a building comprising a plurality of different occupants/tenants e.g. each related to a building unit, other implementations are possible and within the scope of the present disclosure. As such, the expression “building entity” should be interpreted broadly and may in some embodiments relate to any form of unit or area comprised with the building. Furthermore, the expression building entity should also be understood to relate to functions relation to the building, not necessarily having a singular or specific location within the building.

For example, in case the user is a postal worker he may not necessarily have any need to interact with a building unit, but rather with e.g. a “postal area” within the building. When the postal worker thus requests building information and provides a relevant identifier, he will be presented with information that is directly useful for the postal worker and e.g. his work with delivering mail to the occupants of the building. It should be understood that the building information in this embodiment may comprise explicit instructions to the postal worked, e.g. directing him to deliver some of the mail to another location within the building, not being at the postal area. Such information could for example be prestored by one of the occupants/tenants of the building.

Similarly, a parcel delivery person having the intention to deliver food to a cold storage area of the building may his identifier and request information on how to get to the cold storage area. As a response the control system according to the present disclosure may be presented with guiding information to the cold storage area. However, in case there is an issue with the cold storage area, e.g. an administrator of the building may pre-store other information with the control system to direct the parcel delivery person to another location within the building or directly to one of the building units comprised with the building.

Still further, a function of the building may as mentioned above not necessarily have a singular or specific location within the building. Example of such functions may for example include elevators of the building, an electrical system of the building, a ventilation system of the building, or a fire suppression system of the building. Other functions of course exist and are within the scope of the present disclosure. As such, any form of an informative element for the building entity may be provided to the user by means of the display screen.

Furthermore, it should be understood that the user also may be an occupant or tenant of the building. As such, when the occupant of the building e.g. requests entry to the building he may be presented with relevant information for his unit (or similar). Such information could as an example relate to an upcoming and planned power outage, a planned party for all the tenants, etc.

It should of course be understood that in case the user is not correctly identified using the user identifier, it may be possible to not provide any information to the user or to provide generic information not providing any disclosure about the building entity that the user wanted to interact with. Similarly, if the user only provides his (correct) identifier but no information about what building entity the user wants to interact with, the control system may request the user to provide such information. In case the user is determined to not have any relation to a specific building entity, then the user will not be provided with any relevant information as to the specified building entity. Rather, the user may again be presented with generic information. Thus, it should be understood that in line with the present disclosure it is necessary that the user provides both a correct user identifier and be predetermined to have a relation to the specific building entity. If either of the two are determined to be incorrect, then no relevant information is presented, but possibly some generic information relating to the building.

Preferably, the system further comprises an operator interface operated by an occupant of a unit or a manager of the building, wherein the control unit is further adapted to receive, using the operator interface, building information for a specific building entity, wherein the building information is provided with a user specific digitally readable code, such as a tag relating to a specific user identifier, wherein the selection of the building information is further based on a matching between the user identifier comprised with the request and the tag relating to the specific user identifier. The tag relating to the specific user identifier will accordingly be used by the control system for determining if the user is a correct user.

By means of such an implementation it is possible to allow the above-mentioned pre-stored information to be inputted to the database, allowing e.g. other tenants of or a manager/administrator of the building to provide further relevant information for the user in relation to the specific building entity.

In some embodiments of the present disclosure it may be preferred to allow the user access to the building. Thus, in such an embodiment the control unit is further adapted to provide an instruction to the entry interface for operating a passage arrangement at the building, thereby allowing the user to access at least the building and possibly also the relevant building entity. The passage arrangement may not necessarily form part of the control system but may rather be arranged in communication with the control system.

Within the context of the invention, the term “passage arrangement” is meant to comprise electric, electronic or mechatronic locking units and, in particular, locks. In this respect, the electronic entry arrangement may comprise various components such as, e.g., read-out means for identification media, particularly electronic keys, a locking electronics system and the like.

In line with the present disclosure, the control unit may thus be connected with the receiving electronic device operated by the specific occupant as well as the e.g. electronic lock. Once the control unit has decided that the user should be allowed to pass through an entry door of the building, the electronic lock may be unlocked.

The passage arrangement may in some embodiments be used for receiving the user request, for example by means of the above discussed tag or key fob. As such, the tag or key fob may be provided to the passage arrangement using wireless means, such as using NFC or RFID related technology/protocols.

Furthermore, in some embodiment of the present disclosure the entry interface is adapted for providing instructions to a building controller, wherein the building controller adapted for controlling at least one functionality within the building. The at least one functionality within the building may for example be selected from a group comprising operating a luminaire, operating an elevator, operating a second electrically controllable door lock within the building. Accordingly, by means of such an implementation the guiding information may be provided throughout the building for allowing e.g. the parcel delivery person to move to the correct area within the building. It should further be understood that also audio-based information may be presented to the user, such as prestored guiding instruction.

According to another aspect of the present disclosure there is provided a computer implemented method for operating a control system installed at a building comprising a plurality of building entities, wherein the control system is adapted to display dedicated content, the system, the control system comprising a display screen, an entry interface for communicating with an entry system for the building, a database holding building information relating to the building entities, the building entity being one of the plurality of units and the building, and a control unit arranged in communication with the display screen, the entry interface and the database, wherein the method comprises the steps of receiving, by the control unit and using the entry interface, a request from a user to interact with at least one building entity, the request comprising an identifier for the user, selecting, using the control unit and based on the request and from the database, building information relating to the building entity, forming, using the control unit, a set of content based on the user identifier and the selected building information, and displaying, by the control unit using the display screen of the control system, the set of content for the user. This aspect of the present disclosure provides similar advantages as discussed above in relation to the previous aspect of the present disclosure.

According to a still further aspect of the present disclosure there is provided a computer program product comprising a non-transitory computer readable medium having stored thereon computer program means for operating a control system installed at a building comprising a plurality of building entities, wherein the control system is adapted to display dedicated content, the system, the control system comprising a display screen, an entry interface for communicating with an entry system for the building, a database holding building information relating to the building entities, the building entity being one of the plurality of units and the building, and a control unit arranged in communication with the display screen, the entry interface and the database, wherein the computer program product comprises code for receiving, by the control unit and using the entry interface, a request from a user to interact with at least one building entity, the request comprising an identifier for the user, code for selecting, using the control unit and based on the request and from the database, building information relating to the building entity, code for forming, using the control unit, a set of content based on the user identifier and the selected building information, and code for displaying, by the control unit using the display screen of the control system, the set of content for the user. Also this aspect of the present disclosure provides similar advantages as discussed above in relation to the previous aspects of the present disclosure.

A software executed by the server for operation in accordance to the present disclosure may be stored on a computer readable medium, being any type of memory device, including one of a removable nonvolatile random-access memory, a hard disk drive, a floppy disk, a CD-ROM, a DVD-ROM, a USB memory, an SD memory card, or a similar computer readable medium known in the art.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates a control system installed at a building according to a currently preferred embodiment of the present disclosure, and

FIG. 2 shows a flow chart of a method according to an embodiment of the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

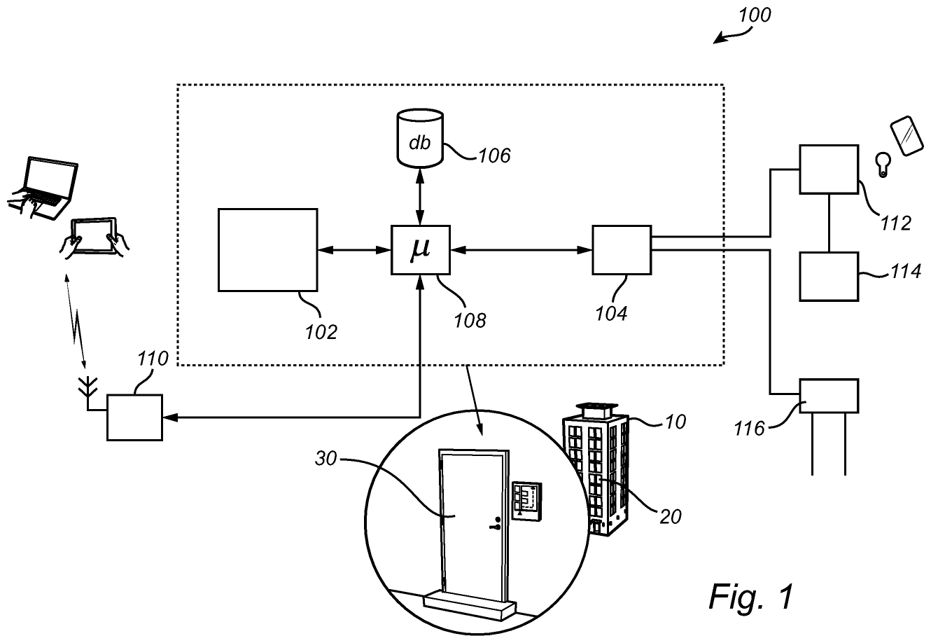

Referring now to the drawings and to FIG. 1 in particular, there is depicted a control system 100, adapted to display dedicated content to a person wanting to interact a building 10, specifically with a building entity 20 comprised with the building 10. The building entity 20 may for example be a building unit (e.g. an apartment, an office, a storage space, a delivery space, etc.) or any other form of dedicated “space” comprised with the building 10.

The control system 100 comprises a display screen 102, for example arranged in such a manner that content displayed at the display screen 102 is visible to the person wanting to interact with the building entity 20, even in case that person is located outside of an entry door 30 of the building 10. The control system 100 further comprises an entry interface 104, where the entry interface 104 is arranged to allow the control system 100 to communicate with e.g. an entry system 112 of the building 10, where such an entry system 112 typically may be used for allowing a user/the above mentioned person to present some form of means communicating an identifier for the user/person. Accordingly, the control system 100 is generally installed at the building 10, preferably in such a manner that at least the entry interface 104 is accessible to the person wanting to interact with the building entity 20, even in case that person is located outside of the entry door 30 of the building 10.

Such an identifier may for example be selected from a group comprising a “tag”, a key card or a mobile phone for example equipped with some form of NFC/RFID capability. It should also be understood that the entry system 112 could include a touch pad, a touch screen or similar where the user/person wanting to interact with the building entity 20 may enter relevant information (as compared to using e.g. a tag, where such information may be pre-stored).

The entry interface 104 may also in some embodiments be used for controlling a first electrically controllable door lock 114, such as for allowing the user/person to enter into the building or a building entity through the door 30.

The control system 100 further comprises a control unit 108 arranged in communication with the display screen 102, the entry interface 104 and a database 106, where the database 106 is arranged to hold building information relating to the building entities 20 of the building 10.

For reference, the control unit 108 may be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

It should further be understood that the functionality provided by the control unit 108 and/or the database 106 may be distributed between different unit, not necessarily located at the building 10. For example, the functionality provided by the control unit 108 and/or the database 106 may be distributed along different entities, and the control unit 108 and/or the database 106 may form part of a so-called cloud server arrangement.

In a preferred embodiment of an implementation of the control system 100, the control system further comprises an operator interface 110, allowing e.g. an occupant of a unit 20 of the building 10 or a manager of the building 10 to provide the above-mentioned building information to be stored with the database 106. For example, each building entity may be provided with a user interface (such as a fixed touch screen and interface mounted in the unit) allowing the occupant of that specific unit to provide content to be provided to a user/person wanting to interact with that specific unit (as such being a building entity 20). Similarly, the manager of the building 10 (or someone having a similar functionality) may provide general information relating to the building entities 20, such as the above-mentioned general information to the occupants or to e.g. emergency or delivery personnel wanting to interact with the building 10 or a building entity 20.

It is however not necessary to equip the building entities 20 with specific user interfaces. Rather, the operator interface 110 may function as a “portal” allowing e.g. personal devices such as mobile phones, laptops, tablets, etc. to be used for providing the mentioned building information. Accordingly, when using e.g. a personal electronic device for entering the building information, such an electronic device may be arranged in a wireless network connection with the operator interface 110. The wireless network connection may for example be implemented using WLAN, CDMA, GSM, GPRS, 3G mobile communications, 4G mobile communications, 5G mobile communications, Bluetooth, infrared, or similar.

In addition to the above, in some embodiments the entry interface 104 may be arranged in communication with a building controller 116. The building controller 116 may in turn be used for controlling specific functionalities within the building 10. As a non-limiting example, the building controller 116 may be used for controlling lights, elevators, doors, etc. within the building 10. As such, once e.g. the user/person wanting to interact with the building entity 20 has passes through the door 30, he/she may be given further assistance to e.g. reach the correct building entity 20 within the building 10. Such assistance may for example include to automatically open specific doors within the building 10, activate a specific elevator (or only allowing the elevator to be operated to a specific level, etc.).

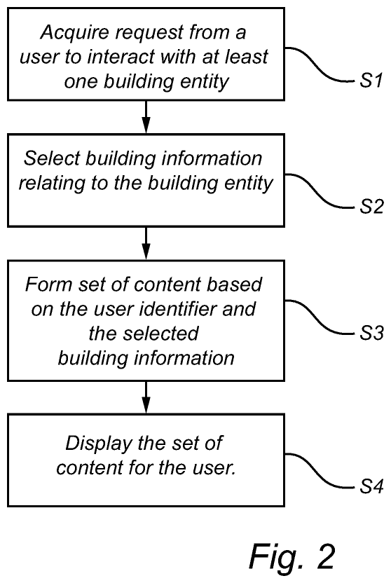

During operation of the control system 100, with further reference to FIG. 2, once a user/person requesting to interact with a building entity 20 of the building, or at least to get in contact with an occupant of one of the building units (here defined as a building entity), he/she may for example present his/her mobile phone or tag to the entry system 112 of the building 10, where the mobile phone or tag is pre-programmed with an identifier for the user/person.

The control unit 108 will then receive, S1, the request from the user/person through the entry interface 104, where the entry interface 104 is as discussed above arranged in communication with the entry system 112. Generally, it may be sufficient for the user/person to just present his tag or mobile phone, and the control unit 108 will based on the identifier for the person find the relevant building entity 20 that the user/person is “normally” or predefined to wanting to interact with. It should however be understood that the entry system 112 may display some form of request to the user/person to enter further information as to what specific building entity to that the user/person would like to interact with.

Additionally to the above, it could within the scope of the present disclosure be possible for the entry system 112 to include e.g. machine code reader, such as a bar code reader, allowing the user/person wanting to interact with the building entity 20 to present such a bar code in front of the machine code reader. In turn, such a bar code could in advance be sent by e.g. the occupant of a specific building entity, or similar, to the user/person wanting to interact with the building entity 20, holding relevant information as to the specific building entity 20 and an relevant identifier for the user/person. Other type of similar machine codes may be used within the concept of the present disclosure, for example including digital keys, etc.

Once the request has been received by the control unit 108, the control unit 108 selects, S2, building information relating to the building entity from the database 106. As mentioned above, the building information is typically entered by the occupant of a unit or a manager of the building. Other information may however be stored with the database 106. As an example, a utility company may in some embodiments be given the possibility to enter information with the database 106, thereby allowing information relating to e.g. a halt in the water/electricity to the building 10 to be presented when a user/person wants to interact with the building entity 20.

It should be understood that the selection of the building information is made based on the request made by the user/person wanting to interact with the building entity 20, where the request (as discussed above) comprises the identifier for the user/person as well as information as to what building entity 20 to interact with.

The control unit 108 further forms, S3, a set of content based on the user identifier and the selected building information. Accordingly, rather than just present general information to the user/person wanting to interact with the building entity 20, the control system 100 according to the present disclosure allows the content to be dedicated to the specific user/person. Additionally, since the request comprises an identifier of the user/person, it may be possible to ensure that unwanted persons are not given the wrong information.

Once the set of content has been created, the control unit 108 displays, S4, the set of content for the user/person wanting to interact with the building entity 20. The content displayed, such as at the display screen 102, may in some embodiments be interactive, allowing the user/person to request further information or more detailed information as needed.

As discussed above, in some embodiment of the present disclosure the content comprises e.g. a guide to the user/person wanting to interact with the building entity 20 as to where to go within the building 10 to interact with the “correct” building entity 20.

In summary, the present disclosure relates to a control system installed at a building comprising a plurality of building entities, for example adapted to selectively display dedicated content relating to guiding instructions or informative elements for the building. The present disclosure also relates to a corresponding method and a computer program product.

By means of the present disclosure, it will be possible to improve the selection of information that is presented to a user, by allowing the information to be “personalized” depending on a combination of an identity of the user and knowledge about what building entity the user wants to interact with. Accordingly, the same user interacting with two different building entities will not necessarily be presented with the same information, but rather information that is dependent of which building entity the user wants to interact with. Similarly, different users wanting to interact with the same building entity must not necessarily be presented with the same information.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Although the figures may show a sequence the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A control system installed at a building comprising a plurality of building entities, wherein the control system is adapted to display dedicated content, the control system comprising:
a display screen,
an entry interface for communicating with an entry system for the building,
a database holding building information relating to the building entities, and
a control unit arranged in communication with the display screen, the entry interface and the database,
wherein the control unit is adapted to:
acquire, using the entry interface, a request from a user to interact with at least one building entity, the request comprising an identifier for the user,
select, based on the request and from the database, building information relating to the building entity,
form a set of content based on the user identifier and the selected building information, and
display, using the display screen of the control system, the set of content for the user.

2. The control system according to claim 1, wherein the system further comprises:
an operator interface operated by an occupant of a unit or a manager of the building,
wherein the control unit is further adapted to:
receive, using the operator interface, building information for a specific building entity, wherein the building information is provided with a tag relating to a specific user identifier,
wherein the selection of the building information is further based on a matching between the user identifier comprised with the request and the tag relating to the specific user identifier.

3. The system according to claim 1, wherein the control unit is further adapted to:
provide an instruction to the entry interface for operating a passage arrangement at the building, thereby allowing the user to access at least one building entity.

4. The control system according to claim 3, further comprising the passage arrangement, and the passage arrangement is adapted to receive the user request.

5. The control system according to claim 4, wherein the user provides the user identifier using wireless communication.

6. The system according to claim 1, wherein the user identifier comprised a user specific digitally readable code.

7. The control system according to claim 3, wherein the passage arrangement comprises a first electrically controllable door lock.

8. The control system according to claim 1, wherein the set of content comprises at least one of a guiding instruction to the building entity or an informative element for the building entity.

9. The control system according to claim 1, wherein the entry interface is adapted for providing instructions to a building controller, the building controller adapted for controlling at least one functionality within the building.

10. The control system according to claim 9, wherein the at least one functionality within the building is selected from a group comprising operating a luminaire, operating an elevator, operating a second electrically controllable door lock within the building.

11. A computer implemented method for operating a control system installed at a building comprising a plurality of building entities, wherein the control system is adapted to display dedicated content, the control system comprising:
a display screen,
an entry interface for communicating with an entry system for the building,
a database holding building information relating to the building entities, and
a control unit arranged in communication with the display screen, the entry interface and the database,
wherein the method comprises the steps of:
receiving, by the control unit and using the entry interface, a request from a user to interact with at least one building entity, the request comprising an identifier for the user,
selecting, using the control unit and based on the request and from the database, building information relating to the building entity,
forming, using the control unit, a set of content based on the user identifier and the selected building information, and
displaying, by the control unit using the display screen of the control system, the set of content for the user.

12. The method according to claim 11, wherein the control system further comprises:
an operator interface operated by an occupant of a unit or a manager of the building, wherein the method further comprises the step of:
receiving, by the control unit and using the operator interface, building information for a specific building entity, wherein the building information is provided with a tag relating to a specific user identifier,
wherein the selection of the building information is further based on a matching between the user identifier comprised with the request and the tag relating to the specific user identifier.

13. The method according to claim 11, wherein the method further comprises the step of:
providing, using the control unit, an instruction to the entry interface for operating a passage arrangement at the building, thereby allowing the user to access at least one building entity.

14. The method according to claim 11, wherein the user identifier comprised a user specific digitally readable code.

15. The method according to claim 11, wherein the set of content comprises at least one of a guiding instruction to the building entity or an informative element for the building entity.

16. The method according to claim 11, further comprising the steps of:
providing, by the control unit and using the entry interface, instructions to a building controller, the building controller adapted for controlling at least one functionality within the building.

17. A computer program product comprising a non-transitory computer readable medium having stored thereon computer program means for operating a control system installed at a building comprising a plurality of building entities, wherein the control system is adapted to display dedicated content, the system, the control system comprising:
a display screen,
an entry interface for communicating with an entry system for the building,
a database holding building information relating to the building entities, and
a control unit arranged in communication with the display screen, the entry interface and the database,
wherein the computer program product comprises:
code for receiving, by the control unit and using the entry interface, a request from a user to interact with at least one building entity, the request comprising an identifier for the user,
code for selecting, using the control unit and based on the request and from the database, building information relating to the building entity,
code for forming, using the control unit, a set of content based on the user identifier and the selected building information, and
code for displaying, by the control unit using the display screen of the control system, the set of content for the user.
